(19) United States
(12) Patent Application Publication
(10) Pub. No.: US 2007/0229422 A1
(43) Pub. Date: Oct. 4, 2007

(54) METHOD AND DEVICE FOR CONTROLLING DELTA PANEL

(75) Inventor: Jui-Hung Hung, Hsinchu (TW)

Correspondence Address: KIRTON AND MCCONKIE, 60 EAST SOUTH TEMPLE,, SUITE 1800, SALT LAKE CITY, UT, 84111, US

(73) Assignee: MSTAR SEMICONDUCTOR, INC., Hsinchu hsien (TW)

(21) Appl. No.: 11/466,933

(22) Filed: Aug. 24, 2006

(30) Foreign Application Priority Data
Apr. 3, 2006 (TW) 095111829

(51) Int. Cl. G09G 3/36

(52) U.S. Cl. 345/88

(57) ABSTRACT

A control device is used with a delta panel of a display for processing and transmitting color data to be displayed on the delta panel according to a pixel clock received from the image processing circuit. A clock duplicating circuit of the control device processes said pixel clock into three clocks with respective frequency smaller than the frequency of the pixel clock. A clock adjusting device of the control device is coupled to the clock-duplicating circuit for processing the resulting three color clocks into a first color clock, a second color clock having a first phase difference from said first color clock, and a third color clock having a second phase difference from said second color clock, wherein the first color clock, the second color clock and the third color clock are output to the delta panel for sampling a first color data, a second color data and a third color data to the delta panel, respectively.

### FIELD OF THE INVENTION

The present invention relates to a panel control method and a panel control device, and more particularly to method and device for controlling a delta panel of a liquid crystal display to increase the quality of the display image.

### BACKGROUND OF THE INVENTION

FIG. 1(a) schematically illustrates pixels of a typical thin-film transistor liquid-crystal display (TFT LCD) strip panel. The TFT LCD strip panel 10 includes a plurality of pixels like pixels 12, 14, 16. Each pixel is composed of red (R), green (G) and blue (B) color elements and generates a different color by adjusting respective brightness of the three color elements. The scan lines of the TFT LCD panel 10 are refreshed according to the R, G and B color data provided by the display controller (not shown). R, G and B color elements of the same pixel are refreshed together at each clock according to a pixel clock, and are thus mixed to show a desired color. After all the pixels on the panel have been refreshed line by line, a full frame can be shown on the TFT LCD panel 10.

FIG. 1(b) is a schematic timing diagram illustrating color data output to the TFT LCD strip panel 10 wherein all three kinds of color data are outputted according to a pixel clock. The pixel clock, R data, G data and B data are generated by processing and/or sampling external video signals to be displayed on the TFT LCD strip panel 10 with an image processing circuit (not shown). The external video signals, for example, can be analog TV signal or digital video signal. The R, G and B data are outputted from the image processing circuit through a R data line, a G data line, and a B data line, respectively. The values of the R data, B data and G data represent the brightness of the color elements, respectively. For example, the R data, G data, and B data corresponding to the rising edge of the first pixel clock cycle drive the three color elements of the first pixel while the R data, G data, and B data corresponding to the second pixel clock cycle drive the three color elements of the second pixel, and so on. Assuming the resolution of the TFT LCD panel 10 is M*N pixels per frame, the R, G and B data outputted in response to the first M pixel clock cycles display the colors of pixels in the first scan line. Likewise, the R, G and B data outputted in response to M*N pixel clock cycles display colors of pixels of the entire image, so as to display a full frame.

Generally, the above-described TFT LCD strip panel is generally for large panels, such as the notebook panel. On the other hand, for small-size panel, pixel reduction is an important issue. A TFT LCD delta panel is generally for the small panel, such as a display panel of a car. FIG. 2(a) schematically shows pixels of a typical TFT LCD delta panel. Each pixel of the TFT LCD delta panel 20 includes only one of the R, G and B color elements which are alternately presented in a horizontal scan line. Moreover, the color elements in adjacent scan lines, e.g. color elements 22, 24 and 26, are allocated so as to combine three different color elements in a triangular form as indicated by a dashed triangle. As such, various brightness combinations of the three color elements result in different colors.

Accordingly, the pixel clock and color data output scheme for refreshing a M*N pixels image frame of the panel in FIG. 1(a) cannot be directly applied to the panel in FIG. 2(a) with the same resolution. Instead, an additional complicated control circuit, conventionally an integrated circuit (IC), needs to be mounted between the image processing circuit and the TFT LCD delta panel for properly converting the color data and pixel clock generated by the image processing circuit before outputting them to the TFT LCD delta panel.

According to the specification of a TFT LCD delta panel, each color element has a corresponding color clock and a corresponding color data line. In other words, the green color element associates with a green clock Clk_1/G and a green data line (G data line); the blue color element associates with a green clock Clk_2/B and a blue data line (B data line); and the red color element associates with a red clock Clk_3/R and a red data line (R data line). A schematic timing diagram of color data outputted by the control circuit is shown in FIG. 2(b), wherein three kinds of color data are outputted according to respective color clocks. Generally, the three color clocks (Clk_1/G, Clk_2/B and Clk_3/R) are generated by processing the pixel clock with a clock generator inside the conventional control circuit. Each of the color clocks has a frequency which is only ⅓ the frequency of the pixel clock. Accordingly, as shown in FIG. 2(b), each kind of color data can be outputted once per three pixel clock cycles and lasts for three pixel clock cycles. The panel 20 displays color data according to the rising edges of respective color clocks, as indicated by arrows in FIG. 2(b). That is, for each kind of color data, only the color data of the first, fourth, seventh, tenth, . . . pixels are outputted and displayed. The three color clocks are outputted to the delta panel 20 for sampling the three color data, respectively

Now take the pixels on the first scan line as an example. During the first M pixel clock cycles, the rising edge of the first green clock is synchronized with the first pixel clock cycle, the rising edge of the first blue clock is synchronized with the second pixel clock cycle, the rising edge of the first red clock is synchronized with the third pixel clock cycle, the rising edge of the second green clock is synchronized with the fourth pixel clock cycle, the rising edge of the second blue clock is synchronized with the fifth pixel clock cycle, the rising edge of the second red clock is synchronized with the sixth pixel clock cycle, and so on. Thus, G, B and R data constituting the M pixels of the first scan line will be alternately and sequentially displayed with M pixel clock cycles. Accordingly, G, B and R data of the entire panel will be alternately and sequentially displayed with M*N pixel clock cycles to show a full image frame.

Obviously, conversion through such a control circuit will reduce the resolution of the image frame. For an M*N pixels image frame, a delta panel can only exhibit ⅓ resolution compared with a strip panel. Conventionally, the delta panel cannot show full image details as in a strip panel. It is then attempted by the invention to improve the image quality of a delta panel.

### SUMMARY OF THE INVENTION

Therefore, the present invention provides a control device for use with a delta panel of a display, which conducts a good balance between pixel reduction and image quality considerations.

In an embodiment, the present invention provides a control device for use with an image processing circuit and a delta panel of a display for processing and transmitting color data to be displayed on the delta panel in response to a pixel clock received from the image processing circuit. The control device includes a clock duplicating circuit for processing the pixel clock into three clocks with respective frequency smaller than the frequency of the pixel clock; and a clock adjusting device coupled to the clock-duplicating circuit for processing the resulting three color clocks into a first color clock, a second color clock having a first phase difference from the first color clock, and a third color clock having a second phase difference from the second color clock, which are referred to for outputting a first color data, a second color data and a third color data to the delta panel, respectively.

In an embodiment, the present invention provides a control method for processing and transmitting color data to be displayed on the delta panel. In the method, a plurality of color data including a first color data, a second color data and a third color data are received from an image processing circuit in response to a pixel clock. A first color clock, a second color clock and a third color clock having respective frequencies smaller than the frequency of the pixel clock and having phase differences therebetween are generated. A series of the first color data to be displayed on the delta panel are outputted in response to the first color clock. A series of the second color data to be displayed on the delta panel are outputted in response to the second color clock. A series of the third color data to be displayed on the delta panel are outputted in response to the third color clock, respectively.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1(a) is a schematic diagram illustrating pixels of a typical TFT LCD strip panel;

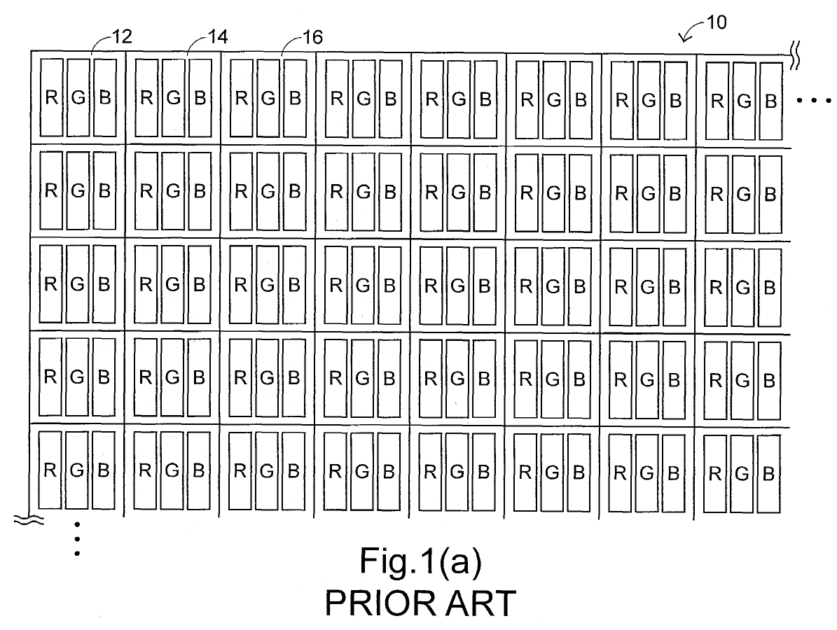

FIG. 1(b) is a timing diagram of color data output to the TFT LCD strip panel;

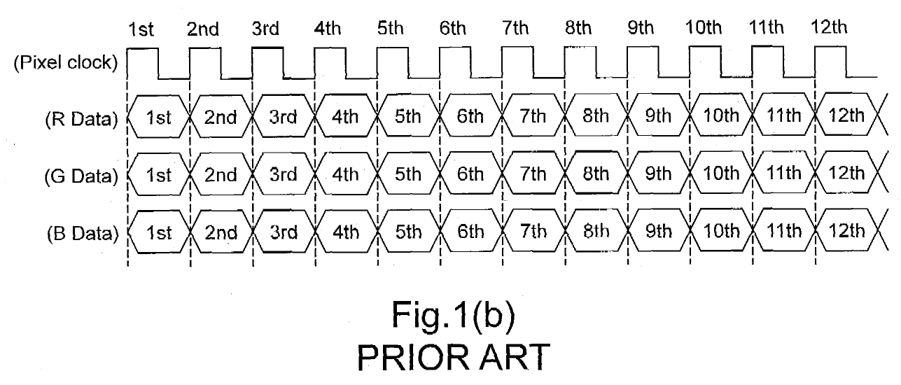

FIG. 2(a) is a scheme illustrating pixels of a typical TFT LCD delta panel;

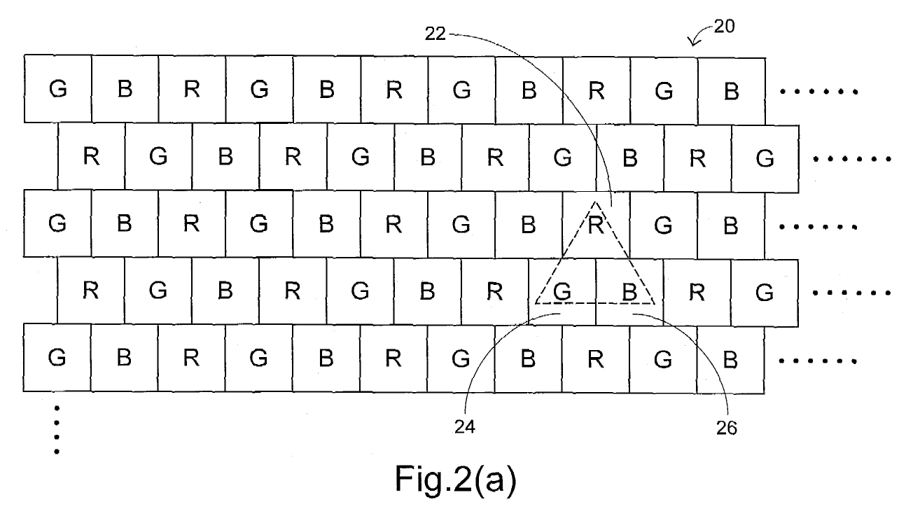

FIG. 2(b) is a timing diagram of color data output from a conventional control circuit of the TFT LCD delta panel of FIG. 2(a) according to prior art;

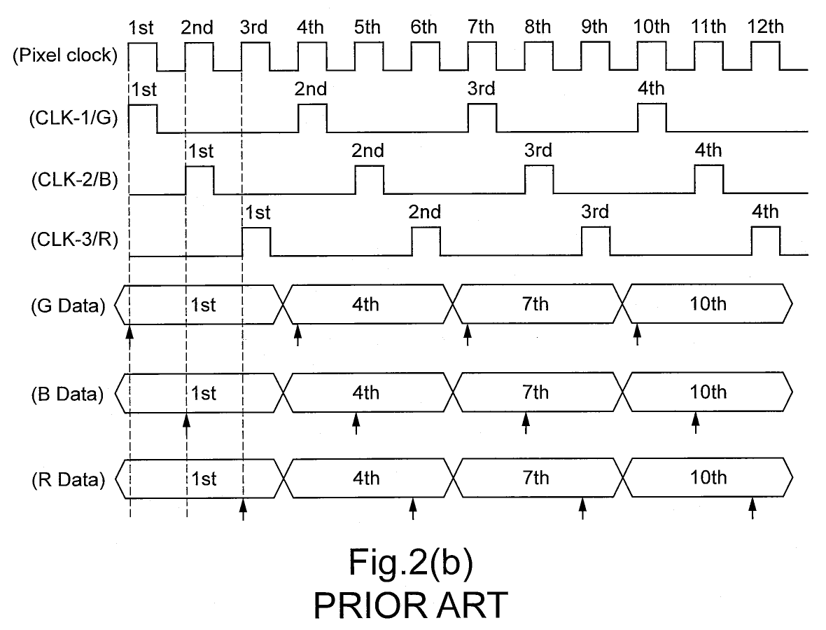

FIG. 3 is a functional block diagram illustrating a control circuit of a TFT LCD delta panel according to an embodiment of the invention;

FIG. 4 is a timing diagram of color data output from a control circuit in an odd field of an interlaced TFT LCD delta panel according to an embodiment of the invention; and

FIG. 5 is a timing diagram of color data output from the control circuit of FIG. 4 in an even field.

### DETAILED DESCRIPTION OF PREFERRED EMBODIMENTS

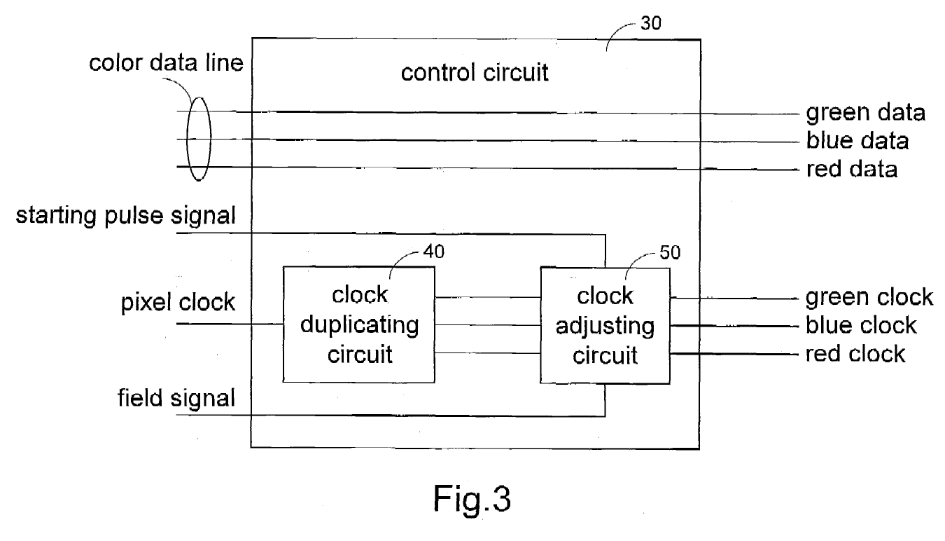

A control circuit for use with a TFT LCD delta panel is disclosed as shown in FIG. 3 for improving the image quality. The control circuit 30 includes a clock duplicating circuit 40 and a clock adjusting device 50. The clock duplicating circuit 40 receives the pixel clock generated by an image processing circuit (not shown) to generate three color clocks, each of which has a frequency being ⅓ that of the pixel clock with 50% duty cycle. The clock adjusting device 50 receives the three color clocks and adjusts the three color clocks in response to a starting pulse signal outputted by the image processing circuit so that every two of the three color clocks have a 120-degree phase difference therebetween. The adjusted color clocks are referred to as green clock Clk_1/G blue clock Clk_2/B and red clock Clk_3/R, respectively. Meanwhile, the color data can be directly outputted by the image processing circuit to the control circuit 30 through color data lines without conversion, and then outputted as G data, B data and R data to be displayed on the TFT LCD delta panel, respectively associated with the color clocks Clk_1/G, Clk_2/B and Clk_3/R. Preferably, the above-mentioned image processing circuit and the control circuit 30 are integrated in a display controller so that the color data and color clocks can be readily outputted from the display controller to the TFT LCD delta panel.

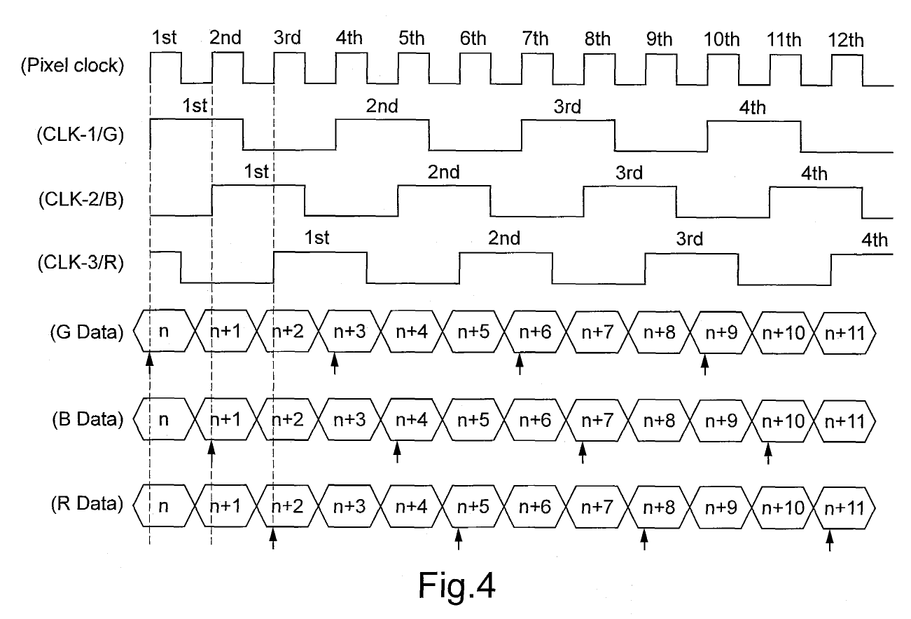

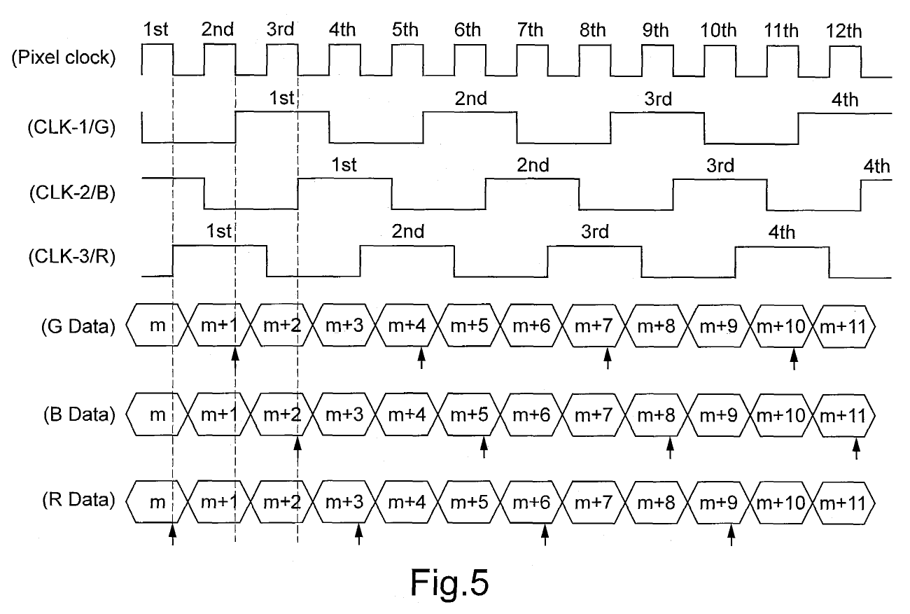

The control circuit of FIG. 3 can be applied with an interlaced TFT LCD delta panel. FIGS. 4 and 5 are timing diagrams of color data output from the control circuit 30 in an odd field and an even field, respectively. In this embodiment, a field signal is inputted to the clock adjusting device 50 as shown in FIG. 3. In response to the field signal, the three color clocks will be inverted with 180 degrees. Since the phase difference between every two of the color clocks Clk_1/G, Clk_2/B and Clk_3/R are adjusted to 120 degrees, the duty cycle is 50% for all color clocks, and the color data are outputted for display in response to rising edges of respective color clocks, each color element will be sequentially and alternately displayed per pixel clock cycle, as indicated by the arrows in FIG. 4 or FIG. 5, and last for one pixel clock cycle. In other words, the three color clocks are selectively inverted in response to the field signal. Color data are displayed with the pixel clock rate and two adjacent data of each color are displayed in two different fields, respectively. Therefore, color data associated with each pixel of a source image can be fully displayed.

In detail, for an odd field, for example, a first pixel of the panel shows a (n)th G data received through the G data line in response to the rising edge of a first green clock that is synchronized with the rising edge of a first pixel clock cycle. Likewise, a second pixel of the panel shows a (n+1)th B data received through the B data line in response to the rising edge of a first blue clock that is synchronized with the rising edge of a second pixel clock cycle; a third pixel of the panel shows a (n+2)th R data received through the R data line in response to the rising edge of a first red clock that is synchronized with the rising edge of a third pixel clock cycle; a fourth pixel of the panel shows the (n+3)th G data in response to the rising edge of a second green clock that is synchronized with the rising edge of a second pixel clock cycle; a fifth pixel of the panel shows the (n+4)th B data in response to the rising edge of a second blue clock that is synchronized with the rising edge of a fifth pixel clock cycle; a sixth pixel of the panel shows the (n+5)th R data in response to the rising edge of a second red clock that is synchronized with the rising edge of a sixth pixel clock cycle, and so on.

Similar derivation can be applied to FIG. 5. For an even field, for example, a first pixel of the panel shows a (m)th R data received through the R data line in response to the rising edge of a first red clock that is synchronized with the falling edge of a first pixel clock cycle; a second pixel of the panel shows a (m+1)th G data received through the G data line in response to the rising edge of a first green clock that is synchronized with the falling edge of a second pixel clock cycle; a third pixel of the panel shows the (m+2)th B data in response to the rising edge of a first blue clock that is synchronized with the rising edge of a third pixel clock cycle; a fourth pixel of the panel shows a (m+3)th R data received through the R data line in response to the rising edge of a second red clock that is synchronized with the falling edge of a fourth pixel clock cycle; a fifth pixel of the panel shows a (m+4)th G data received through the G data line in response to the rising edge of a second green clock that is synchronized with the falling edge of a fifth pixel clock cycle; and a sixth pixel of the panel shows the (m+5)th B data in response to the rising edge of a second blue clock that is synchronized with the falling edge of a sixth pixel clock cycle, and so on. In this way, each pixel displays only one color data so as to comply with the pixel simplification requirement. Since color data can be outputted with higher frequency and alternately displayed in the odd field and the even field, colors of adjacent pixels can be well mixed due to photogene effect so as to improve image quality.

Although FIG. 4 and FIG. 5 are exemplified for a control circuit of an interlaced TFT LCD delta panel in alternate fields. Either of them can be used to show the timing sequence in a control circuit of a non-interlaced TFT LCD delta panel. Aside from, although in the above example, the color data are outputted for display in response to rising edges of respective color clocks, the color data can also be outputted for display in response to falling edges of respective color clocks. Moreover, although in the above example, the rising edges of the color clocks are synchronized with the rising edges of pixel clocks in the odd field, and the rising edges of the color clocks are synchronized with the falling edges of pixel clocks in the even field, they can be switched for achieving the same purpose.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control device for use with a delta panel of a display for processing and transmitting color data to be displayed on the delta panel according to a pixel clock received from an image processing circuit, comprising:
a clock duplicating circuit for generating three clocks with respective frequency smaller than the frequency of said pixel clock by processing said pixel clock; and
a clock adjusting device coupled to said clock-duplicating circuit for processing said three color clocks into a first color clock, a second color clock having a first phase difference from said first color clock, and a third color clock having a second phase difference from said second color clock, wherein said first color clock, said second color clock and said third color clock are output to the delta panel for sampling a first color data, a second color data and a third color data, respectively.

2. The control device according to claim 1 wherein said first color data, said second color data and said third color data are transmitted from the image processing circuit to the delta panel through said control circuit without any conversion.

3. The control device according to claim 1 wherein said first color data, said second color data and said third color data are a green data, a blue data and a red data, respectively, and said first color clock, said second color clock and said third color clock are a green clock, a blue clock and a red clock, respectively.

4. The control device according to claim 1 wherein said clock adjusting device starts processing said pixel clock in response to a starting pulse signal.

5. The control signal according to claim 1 wherein said clock adjusting device adjusts phases of said first color clock, said second color clock and said third color clock in response to a field signal.

6. The control signal according to claim 5 wherein said first color clock, said second color clock and said third color clock are selectively inverted in response to said field signal.

7. The control device according to claim 1 wherein said first color clock, said second color clock and said third color clock substantially have the same duty cycle of 50%.

8. The control device according to claim 1 wherein said first color clock, said second color clock and said third color clock have the same frequency.

9. The control device according to claim 8 wherein the frequency of said first color clock, said second color clock and said third color clock is ⅓ the frequency of said pixel clock.

10. The control device according to claim 9 wherein said first phase difference and said second phase difference are both 120 degrees.

11. The control device according to claim 1 wherein said control device is integrated in a display controller along with the image processing circuit.

12. A method for processing a pixel clock and color data to be displayed on the delta panel, comprising steps of:
generating a first color clock, a second color clock and a third color clock having respective frequencies smaller than the frequency of a pixel clock and having a predetermined phase difference therebetween, and outputting said first color clock, said second color clock and said third color clock to the delta panel according to said pixel clock; and
outputting a first color data, a second color data, and a third color data to be displayed on the delta panel according to said pixel clock.

13. The method according to claim 12 wherein said first color clock, said second color clock and said third color clock are generated according to said pixel clock.

14. The method according to claim 12 wherein said first color clock, said second color clock and said third color clock substantially have the same frequency and 50% duty cycle.

15. The method according to claim 12 wherein the frequency of said first color clock, said second color clock and said third color clock is ⅓ the frequency of said pixel clock.

16. The method according to claim 12 wherein said predetermined phase difference between every two of said first color clock, said second color clock and said third color clock is substantially 120 degrees.

17. The method according to claim 12 wherein said first color data, said second color data and said third color data are sequentially displayed on the delta panel according to alternately occurring rising edges of said first color clock, said second color clock and said third color clock, respectively.

18. The method according to claim 17 wherein each of said rising edges of said first color clock, said second color clock and said third color clock is synchronized with a rising edge of said pixel clock.

19. The method according to claim 17 wherein each of said rising edges of said first color clock, said second color clock and said third color clock is synchronized with a falling edge of said pixel clock.

20. The method according to claim 12 further comprising a step of:
inverting each of said first color clock, said second color clock and said third color clock to generate a first inverted color clock, a second inverted color clock and a third inverted color clock in response to a field signal.

21. The method according to claim 20 further comprising a step of:
alternately displaying said first color data, said second color data and said third color data to the delta panel according to alternately occurring rising edges of said first inverted color clock, said second inverted color clock and said third inverted color clock, respectively.
